(19) United States
(12) Patent Application Publication
(10) Pub. No.: US 2026/0304459 A1
(43) Pub. Date: Oct. 1, 2026

(54) MULTICAST CHANNEL SCHEDULING WITH TIME DELAY

(71) Applicant: QUALCOMM Incorporated, San Diego, CA (US)

(72) Inventors: Ayan SENGUPTA, Mountain View, CA (US); Alberto RICO ALVARINO, San Diego, CA (US)

(21) Appl. No.: 19/570,798

(22) Filed: Mar. 18, 2026

Related U.S. Application Data
(60) Provisional application No. 63/780,013, filed on Mar. 28, 2025.

(51) Int. Cl. H04W 72/30; H04W 72/121; H04W 72/231

(52) U.S. Cl. CPC H04W 72/30; H04W 72/121; H04W 72/231

(57) ABSTRACT

A UE receives a multicast channel scheduling information (MSI) medium access control-control element (MAC-CE) scheduling multiple multicast traffic channel (MTCH) transmissions in a multicast channel (MCH) scheduling period. The UE receives one or more of the multiple MTCH transmissions based on scheduling information in the MSI MAC-CE and a scheduling delay between the MSI MAC-CE and a first MTCH transmission of the multiple MTCH transmissions that is based at least in part on a threshold time gap.

### CROSS REFERENCE TO RELATED APPLICATION(S)

The present application for patent claims priority under 35 U.S.C. § 119 to U.S. Provisional Patent Application No. 63/780,013, filed Mar. 28, 2025 and entitled “Multicast Channel Scheduling with Time Delay,” which is assigned to the assignee hereof and hereby expressly incorporated by reference herein.

### TECHNICAL FIELD

The present disclosure relates generally to communication systems, and more particularly, to wireless communication that includes a multicast channel.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. Examples of telecommunication standards include 4G Long Term Evolution (LTE) standard and 5G New Radio (NR), among other examples. 4G LTE and 5G NR are part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Some aspects of future wireless communication technology, such as 6G may be based on aspects of 5G NR or 4G LTE. There exists a need for further improvements in wireless communication technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus is configured to receive a multicast channel scheduling information (MSI) medium access control-control element (MAC-CE) scheduling multiple multicast traffic channel (MTCH) transmissions in a multicast channel (MCH) scheduling period; and receive one or more of the multiple MTCH transmissions based on scheduling information in the MSI MAC-CE and a scheduling delay between the MSI MAC-CE and a first MTCH transmission of the multiple MTCH transmissions that is based at least in part on a threshold time gap.

In an aspect of the disclosure, a method, a computer-readable medium, and an apparatus are provided for wireless communication at a network node. The apparatus is configured to transmit a multicast channel scheduling information (MSI) medium access control-control element (MAC-CE) scheduling multiple multicast traffic channel (MTCH) transmissions in a multicast channel (MCH) scheduling period; and transmit the multiple MTCH transmissions based on scheduling information in the MSI MAC-CE and a scheduling delay between the MSI MAC-CE and a first MTCH transmission of the multiple MTCH transmissions that is based at least in part on a threshold time gap.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network, in accordance with various aspects of the present disclosure.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3A is a diagram illustrating an example of a first frame, in accordance with various aspects of the present disclosure.

FIG. 3B is a diagram illustrating an example of downlink (DL) channels within a subframe, in accordance with various aspects of the present disclosure.

FIG. 3C is a diagram illustrating an example of a second frame, in accordance with various aspects of the present disclosure.

FIG. 3D is a diagram illustrating an example of uplink (UL) channels within a subframe, in accordance with various aspects of the present disclosure.

FIG. 4 is a diagram illustrating an example of a base station and user equipment (UE) in an access network, in accordance with various aspects of the present disclosure.

FIG. 5A, FIG. 5B, and FIG. 5C illustrate example aspects of MBMS communication, in accordance with various aspects of the present disclosure.

FIG. 6 illustrates example aspects of scheduling MTCH transmissions in an MCH scheduling period, in accordance with various aspects of the present disclosure.

FIG. 7 illustrates example aspects of time-interleaving for MTCH transmissions, in accordance with various aspects of the present disclosure.

FIG. 8 illustrates example aspects of spillover between MCH scheduling periods, such that a remaining portion of an MTCH from a prior scheduling period is transmitted in the following MCH scheduling period, in accordance with various aspects of the present disclosure.

FIG. 9 illustrates example aspects of an MSI MAC-CE with a starting offset indication, in accordance with various aspects of the present disclosure.

FIG. 10 illustrates example aspects of MTCH reception within an MCH scheduling period, in accordance with various aspects of the present disclosure.

FIG. 11 illustrates example aspects of MTCH reception within an MCH scheduling period and including a spillover of MTCH from a prior scheduling period, in accordance with various aspects of the present disclosure.

FIG. 12 illustrates example aspects of time-interleaved MTCH reception within an MCH scheduling period, including a spillover of MTCH from a prior scheduling period, in accordance with various aspects of the present disclosure.

FIG. 13A and FIG. 13B illustrate example aspects of use of a minimum time gap between an MSI and a first scheduled MTCH, in accordance with various aspects of the present disclosure.

FIG. 14 is a communication flow between a UE and a network node, in accordance with various aspects of the present disclosure.

FIG. 15A and FIG. 15B are flowcharts of methods of wireless communication, in accordance with various aspects of the present disclosure.

FIG. 16 is a flowchart of a method of wireless communication, in accordance with various aspects of the present disclosure.

FIG. 17 is a diagram illustrating an example of a hardware implementation for an example apparatus and/or network entity.

FIG. 18 is a diagram illustrating an example of a hardware implementation for an example network entity.

### DETAILED DESCRIPTION

For multimedia broadcast multicast services (MBMS) communication, a network node transmits a multicast channel scheduling information (MSI) medium access control-control element (MAC-CE) at the beginning of each multicast channel (MCH) scheduling period. The MSI MAC-CE provides scheduling information for each multicast traffic channel (MTCH) that is scheduled during the MCH scheduling period. The network node may then transmit the first scheduled MTCH transmission directly after the MSI transmission. As it takes time for the UE to decode the MSI MAC-CE to determine the scheduling information for the MTCH of interest among various MTCHs scheduled by the MSI MAC-CE, the UE may decode and buffer the data received before it finishes decoding the MSI MAC-CE. If the buffered data is not for an MTCH that the UE intends to receive, the UE can then discard the buffered data and stop decoding the data once the UE determines the scheduling information from the MSI. In some aspects, part of an MTCH scheduled in a prior MCH scheduling period may spill over to the next MCH scheduling period. The remaining portion of the spillover MTCH from a prior MCH scheduling period is transmitted after the MSI of a current MCH scheduling period. Therefore, some of the data buffered by the UE while it processes the MSI of the current MCH scheduling period may be for a spillover MTCH. In some aspects, at least one MTCH in the current MCH scheduling period may be time-interleaved. As time-interleaving parameters may vary and a portion of data to be buffered during the MSI processing time may be a spillover MTCH having different time-interleaving parameters, the UE does not decode the data and buffers the data at a physical (PHY) layer. The buffering at the UE adds complexity for the UE to receive the intended MTCH and uses additional power at the UE.

Aspects presented herein provide for a minimum time gap offset between an MSI MAC-CE and a first MTCH scheduled by the MSI, which helps the UE to save power and reduces complexity at the UE by enabling the UE to avoid decoding, buffering, and/or buffering non-de-rate-matched data while the UE processes an MSI to determine scheduling information for one or more MTCHs of interest to the UE. By reducing the buffering at the UE, the UE saves power at the UE and the UE's reception of the MTCH is simplified.

As presented herein, a minimum time gap can be used before the first MTCH is scheduled by an MSI in a MCH scheduling period. The UE's reception may be based on scheduling information in the MSI MAC-CE and a scheduling delay between the MSI MAC-CE and a first MTCH transmission of the multiple MTCH transmissions that is based at least in part on a threshold time gap. In some aspects, the scheduling delay (e.g., a minimum time gap) can be used between the MSI and the first time-interleaved MTCH scheduled by an MSI in an MCH scheduling period. In other aspects, the minimum time gap can be used before the first MTCH scheduled by an MSI in an MCH scheduling period, where the first MTCH is non-time-interleaved. The use of the minimum time gap can help the UE to avoid buffering data, that is not for the MTCH that the UE intends to receive, during the MSI processing time and/or to avoid buffering at a PHY level during the MSI processing time. The use of the minimum time gap also provides a power savings benefit for non-time-interleaved MTCHs, e.g., when the MTCH immediately following the MSI is not an MTCH of interest to the UE.

For example the minimum time gap (e.g., the start point offset) may be based on:

$$Start point offset = max \{ {T}_{p r o c} , {T}_{s p i l l o v e r} \}$$

In this example, T_{proc} denotes a time for the UE to process the MSI, and Tₛₚᵢₗₗₒᵥₑᵣ denotes a time for the transmission of the remaining MTCH from the prior MCH scheduling period that spills over to transmission in the current MCH scheduling period. Among other example values, T_{proc} may be between 1-5 ms, such as 2 or 3 milliseconds. In some aspects, the value for T_{proc} may be defined, e.g., defined in a wireless standard, and known by the UE and the network node without additional signaling to inform each other of the value. In other aspects, the network node may configure the value of T_{proc}, and transmit the configuration, which is received by the UE. The aspects presented herein reduce complexity in the UE reception of MTCH transmissions by reducing buffering and/or decoding at the UE. Furthermore, when an MTCH is time-interleaved, the aspects presented herein provided additional efficiencies for the UE by allowing the UE to skip buffering of data at the physical layer while decoding an MSI MAC-CE.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

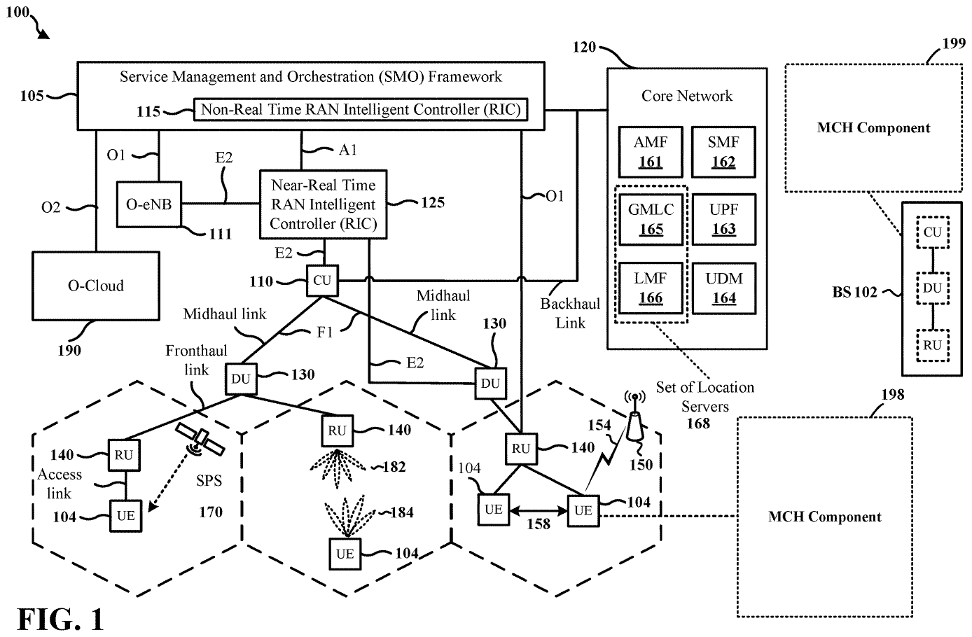

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system, sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a component 198 that may be configured to receive a multicast channel scheduling information (MSI) medium access control-control element (MAC-CE) scheduling multiple multicast traffic channel (MTCH) transmissions in a multicast channel (MCH) scheduling period; and receive one or more of the multiple MTCH transmissions based on scheduling information in the MSI MAC-CE and a scheduling delay between the MSI MAC-CE and a first MTCH transmission of the multiple MTCH transmissions that is based at least in part on a threshold time gap. In certain aspects, the base station 102 may have a component 199 that may be configured to transmit a multicast channel scheduling information (MSI) medium access control-control element (MAC-CE) scheduling multiple multicast traffic channel (MTCH) transmissions in a multicast channel (MCH) scheduling period; and transmit the multiple MTCH transmissions based on scheduling information in the MSI MAC-CE and a scheduling delay between the MSI MAC-CE and a first MTCH transmission of the multiple MTCH transmissions that is based at least in part on a threshold time gap.

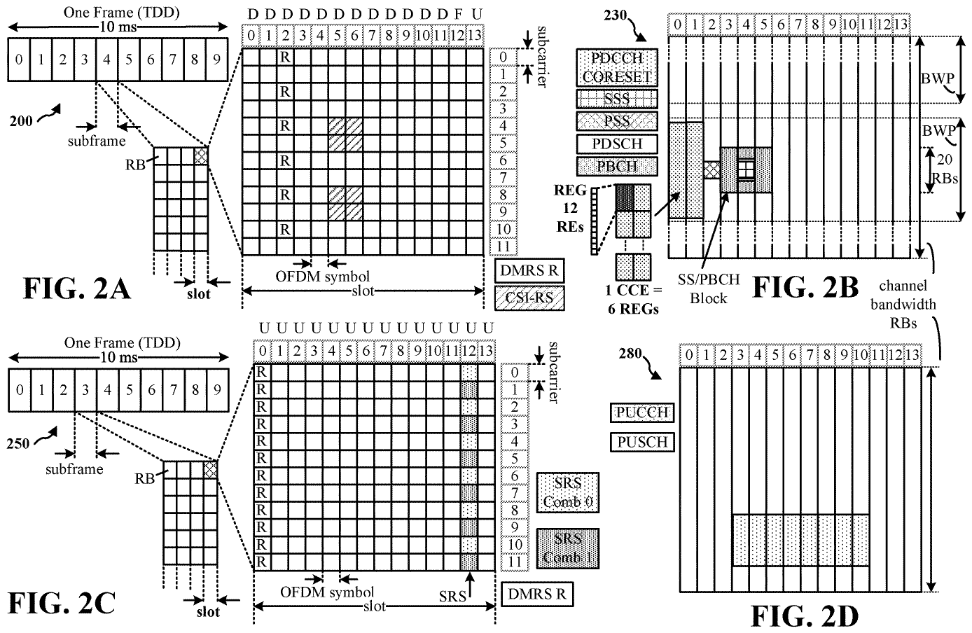

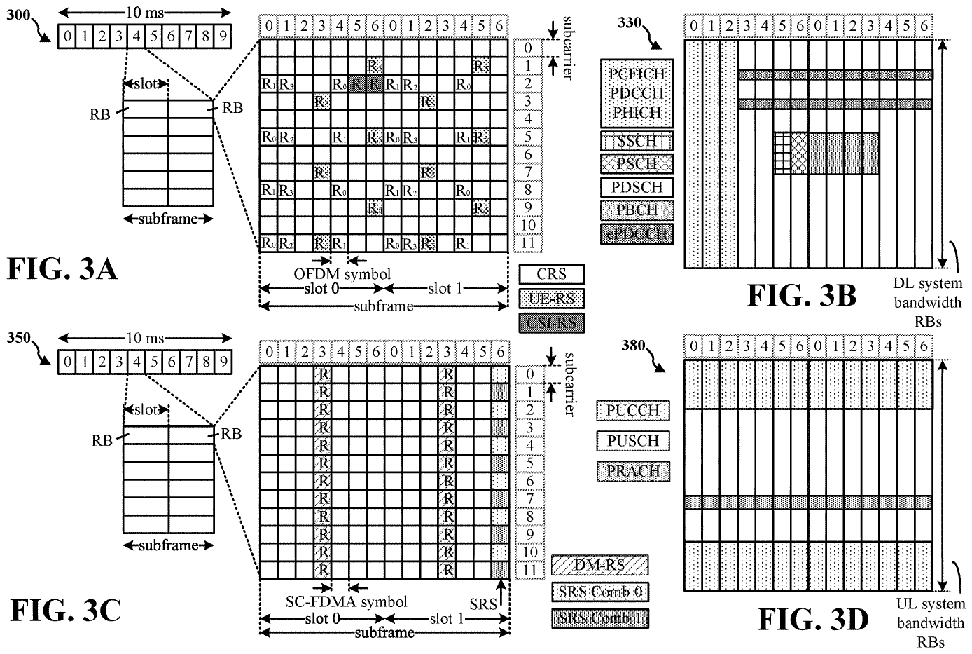

Wireless communication may be based on a frame structure. As an example of a frame structure, FIGS. 2A-2D illustrate various aspects of a 5G NR frame structure. As another example of a frame structure, FIGS. 3A-3D illustrate various aspects of a 4G LTE frame structure. FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

FIG. 3A is a diagram 300 illustrating an example of a DL frame structure in LTE. FIG. 3B is a diagram 330 illustrating an example of channels within the DL frame structure in LTE. FIG. 3C is a diagram 350 illustrating an example of an UL frame structure in LTE. FIG. 3D is a diagram 380 illustrating an example of channels within the UL frame structure in LTE. Other wireless communication technologies may have a different frame structure and/or different channels. In LTE, a frame (10 ms) may be divided into 10 equally sized subframes. Each subframe may include two consecutive time slots. A resource grid may be used to represent the two time slots, each time slot including one or more time concurrent resource blocks (RBs) (also referred to as physical RBs (PRBs)). The resource grid is divided into multiple resource elements (REs). In LTE, for a normal cyclic prefix, an RB contains 12 consecutive subcarriers in the frequency domain and 7 consecutive symbols (for DL, OFDM symbols; for UL, SC-FDMA symbols) in the time domain, for a total of 84 REs. For an extended cyclic prefix, an RB contains 12 consecutive subcarriers in the frequency domain and 6 consecutive symbols in the time domain, for a total of 72 REs. The number of bits carried by each RE depends on the modulation scheme.

As illustrated in FIG. 3A, some of the REs carry DL reference (pilot) signals (DL-RS) for channel estimation at the UE. The DL-RS may include cell-specific reference signals (CRS) (also sometimes called common RS), UE-specific reference signals (UE-RS), and channel state information reference signals (CSI-RS). FIG. 3A illustrates CRS for antenna ports 0, 1, 2, and 3 (indicated as R₀, R₁, R₂, and R₃, respectively), UE-RS for antenna port 5 (indicated as R₅), and CSI-RS for antenna port 15 (indicated as R). FIG. 3B illustrates an example of various channels within a DL subframe of a frame. The physical control format indicator channel (PCFICH) is within symbol 0 of slot 0, and carries a control format indicator (CFI) that indicates whether the physical downlink control channel (PDCCH) occupies 1, 2, or 3 symbols (FIG. 2B illustrates a PDCCH that occupies 3 symbols). The PDCCH carries downlink control information (DCI) within one or more control channel elements (CCEs), each CCE including nine RE groups (REGs), each REG including four consecutive REs in an OFDM symbol. A UE may be configured with a UE-specific enhanced PDCCH (ePDCCH) that also carries DCI. The ePDCCH may have 2, 4, or 8 RB pairs (FIG. 3B shows two RB pairs, each subset including one RB pair). The physical hybrid automatic repeat request (ARQ) (HARQ) indicator channel (PHICH) is also within symbol 0 of slot 0 and carries the HARQ indicator (HI) that indicates HARQ acknowledgement (ACK)/negative ACK (NACK) feedback based on the physical uplink shared channel (PUSCH). The primary synchronization channel (PSCH) is within symbol 6 of slot 0 within subframes 0 and 5 of a frame, and carries a primary synchronization signal (PSS) that is used by a UE to determine subframe timing and a physical layer identity. The secondary synchronization channel (SSCH) is within symbol 5 of slot 0 within subframes 0 and 5 of a frame, and carries a secondary synchronization signal (SSS) that is used by a UE to determine a physical layer cell identity group number. Based on the physical layer identity and the physical layer cell identity group number, the UE can determine a physical cell identifier (PCI). Based on the PCI, the UE can determine the locations of the aforementioned DL-RS. The physical broadcast channel (PBCH) is within symbols 0, 1, 2, 3 of slot 1 of subframe 0 of a frame, and carries a master information block (MIB). The MIB provides a number of RBs in the DL system bandwidth, a PHICH configuration, and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry demodulation reference signals (DM-RS) for channel estimation at the eNB. The UE may additionally transmit sounding reference signals (SRS) in the last symbol of a subframe. The SRS may have a comb structure, and a UE may transmit SRS on one of the combs. The SRS may be used by an eNB for channel quality estimation to enable frequency-dependent scheduling on the UL. FIG. 3D illustrates an example of various channels within an UL subframe of a frame. A physical random access channel (PRACH) may be within one or more subframes within a frame based on the PRACH configuration. The PRACH may include six consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

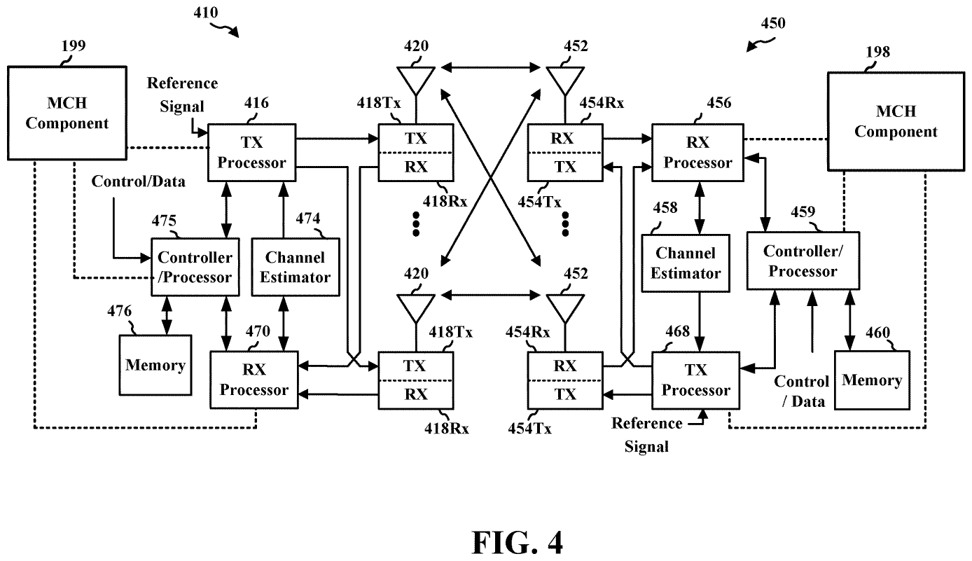

FIG. 4 is a block diagram that illustrates an example of a first wireless device that is configured to exchange wireless communication with a second wireless device. In the illustrated example of FIG. 4, the first wireless device may include a base station 410, the second wireless device may include a UE 450, and the base station 410 may be in communication with the UE 450 in an access network. As shown in FIG. 4, the base station 410 includes a transmit processor (TX processor 416), a transmitter 418Tx, a receiver 418Rx, antennas 420, a receive processor (RX processor 470), a channel estimator 474, a controller/processor 475, and at least one memory 476 (e.g., one or more memories). The example UE 450 includes antennas 452, a transmitter 454Tx, a receiver 454Rx, an RX processor 456, a channel estimator 458, a controller/processor 459, at least one memory 460 (e.g., one or more memories), and a TX processor 468. In other examples, the base station 410 and/or the UE 450 may include additional or alternative components.

In the DL, Internet protocol (IP) packets may be provided to the controller/processor 475. The controller/processor 475 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 416 and the RX processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna of the antennas 420 via a separate transmitter (e.g., the transmitter 418Tx). Each transmitter 418Tx may modulate a radio frequency (RF) carrier with a respective spatial stream for transmission.

At the UE 450, each receiver 454Rx receives a signal through its respective antenna of the antennas 452. Each receiver 454Rx recovers information modulated onto an RF carrier and provides the information to the RX processor 456. The TX processor 468 and the RX processor 456 implement layer 1 functionality associated with various signal processing functions. The RX processor 456 may perform spatial processing on the information to recover any spatial streams destined for the UE 450. If multiple spatial streams are destined for the UE 450, two or more of the multiple spatial streams may be combined by the RX processor 456 into a single OFDM symbol stream. The RX processor 456 then converts the OFDM symbol stream from the time domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the controller/processor 459, which implements layer 3 and layer 2 functionality.

The controller/processor 459 can be associated with the at least one memory 460 that stores program codes and data. The at least one memory 460 may be referred to as a computer-readable medium. In the UL, the controller/processor 459 provides demultiplexing between transport and logical channels, packet reassembly, deciphering, header decompression, and control signal processing to recover IP packets. The controller/processor 459 is also responsible for error detection using an ACK and/or NACK protocol to support HARQ operations.

Similar to the functionality described in connection with the DL transmission by the base station 410, the controller/processor 459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 458 from a reference signal or feedback transmitted by the base station 410 may be used by the TX processor 468 to select the appropriate coding and modulation schemes, and to facilitate spatial processing. The spatial streams generated by the TX processor 468 may be provided to different antenna of the antennas 452 via separate transmitters (e.g., the transmitter 454Tx). Each transmitter 454Tx may modulate an RF carrier with a respective spatial stream for transmission.

The UL transmission is processed at the base station 410 in a manner similar to that described in connection with the receiver function at the UE 450. Each receiver 418Rx receives a signal through its respective antenna of the antennas 420. Each receiver 418Rx recovers information modulated onto an RF carrier and provides the information to the RX processor 470.

The controller/processor 475 can be associated with the at least one memory 476 that stores program codes and data. The at least one memory 476 may be referred to as a computer-readable medium. In the UL, the controller/processor 475 provides demultiplexing between transport and logical channels, packet reassembly, deciphering, header decompression, control signal processing to recover IP packets. The controller/processor 475 is also responsible for error detection using an ACK and/or NACK protocol to support HARQ operations.

At least one of the TX processor 468, the RX processor 456, and the controller/processor 459 may be configured to perform aspects in connection with the MCH component 198 of FIG. 1.

At least one of the TX processor 416, the RX processor 470, and the controller/processor 475 may be configured to perform aspects in connection with the MCH component 199 of FIG. 1.

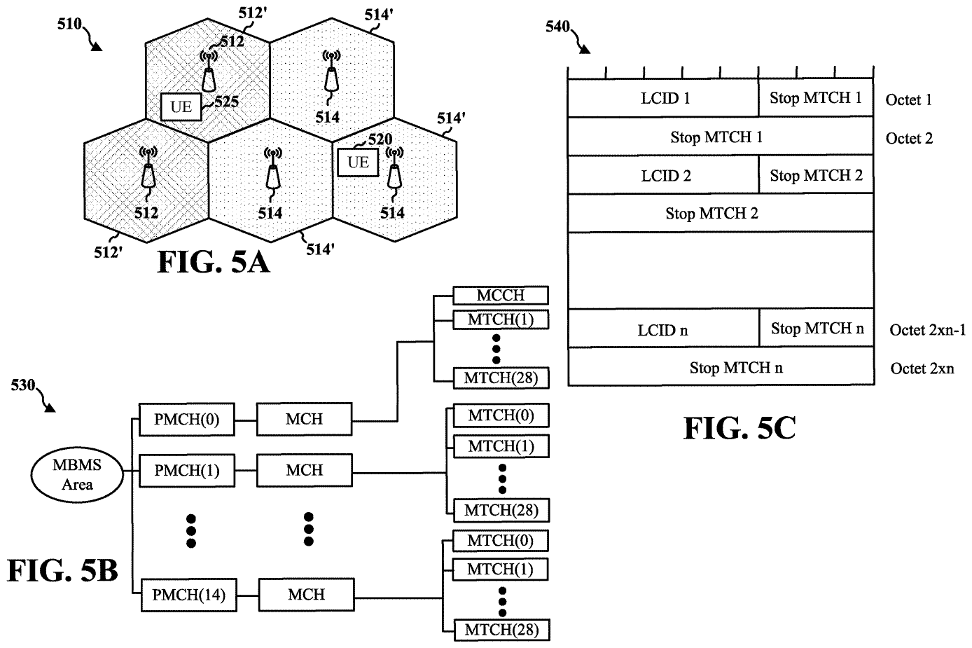

FIG. 5A is a diagram 510 illustrating an example of multimedia broadcast multicast services (MBMS) areas (e.g., in which multicast channel (MCH) transmissions are provided) in an access network. MBMS may also be referred to as multicast broadcast service (MBS), for example. The network node 512 (e.g., a base station or a TRP) in cells 512′ may form a first MBMS area and the network node 514 (e.g., base station or one or more components of a base station) in cells 514′ may form a second MBMS area. The network nodes 512, 514 may each be associated with other MBMS areas. A cell within an MBMS area may be designated a reserved cell. Reserved cells may not provide multicast/broadcast content, but may be time-synchronized to the cells 512′, 514′ and may have restricted power on MBMS resources in order to limit interference to the MBMS areas. Each network node in an MBMS area synchronously transmits the same MBMS control information and data. Each area may support broadcast, multicast, and unicast services. A unicast service is a service intended for a specific user, e.g., a voice call to a particular UE. A multicast service is a service that may be received by a group of users and may also be referred to as a groupcast, e.g., a subscription video service. A broadcast service is a service that may be received by any user within the coverage area, e.g., a news broadcast. Referring to FIG. 5A, the first MBMS area may support a first MBMS broadcast service, such as by providing a particular news broadcast to UE 525. The second MBMS area may support a second MBMS broadcast service, such as by providing a different news broadcast to UE 520.

FIG. 5B is a diagram 530 illustrating an example of an multicast channel (MCH) configuration in an MBMS. As shown in FIG. 5B, each MBMS area supports one or more physical multicast channels (PMCH) (e.g., 15 PMCHs). Each PMCH corresponds to an MCH. Each MCH can multiplex a plurality (e.g., 29) of multicast logical channels. Each MBS area may have one multicast control channel (MCCH). As such, one MCH may multiplex one MCCH and a plurality of multicast traffic channels (MTCHs) and the remaining MCHs may multiplex a plurality of MTCHs.

A UE can camp on a cell to discover the availability of MBMS service access and a corresponding access stratum configuration. Initially, the UE may acquire a SIB that includes information that enables the UE to acquire an MBS area configuration message on an MCCH. Subsequently, based on the MBMS area configuration message, the UE may acquire a multicast channel scheduling information (MSI) medium access control-control element (MAC-CE). The SIB may include an MBMS area identifier of each MBMS area supported by the cell and information for acquiring the MCCH. There may be one MBMS area configuration message for each MBMS area. The MBMS area configuration message may indicate a temporary mobile group identity (TMGI) and an optional session identifier of each MTCH identified by a logical channel identifier within the PMCH and allocated resources in time and/or frequency for each PMCH of the MBMS area. A particular TMGI identifies a particular service of available MBMS services.

MCH transmission may occur in time periods (such as subframes) configured by upper layer for MCCH or MTCH transmission. The time periods may be referred to as “scheduling periods.” For each such time period (e.g., each subframe), the upper layer indicates if signallingMCS or dataMCS applies. The transmission of an MCH may occur in a set of subframes indicated by a PMCH configuration (e.g., which may be referred to as a “PMCH-Config”). An MSI MAC-CE is included in the first subframe allocated to the MCH within an MCH scheduling period to indicate the position of each MTCH and unused subframes on the MCH. In some aspects, such as if pmch-InfoListExt is configured for an MCH, an extended MSI MAC-CE may be included in the first subframe allocated to the corresponding MCH within the MCH scheduling period to indicate the position of each MTCH and unused subframes on the MCH, and to indicate whether MTCH transmission is to be suspended. The MAC entity can then assume that the first scheduled MTCH starts immediately after the MCCH or the MSI MAC-CE or the extended MSI MAC-CE if the MCCH is not present, and the other scheduled MTCH(s) start immediately after the previous MTCH, at the earliest in the subframe where the previous MTCH stops. When the MAC entity (e.g., of the UE) is to receive MCH, the MAC entity (e.g., UE) attempts to decode the TB on the MCH. If a TB on the MCH has been successfully decoded, the UE demultiplexes the MAC PDU, and the MAC entity delivers the MAC SDU(s) to upper layers. When the MAC entity (e.g., of the UE) receives the extended MSI MAC-CE, the MAC entity indicates the MTCH(s) to be suspended to the upper layers. The MAC entity continues to receive the MCH, e.g., until the MTCH is removed from the MCCH.

FIG. 5C illustrates example aspects of an MSI MAC-CE 540 that includes scheduling information for one or more MTCHs. The MSI MAC-CE 540 is identified by a MAC PDU subheader with a logical channel identifier (LCID) as specified in Table 2. This control element has a variable size, e.g., based on the number n of MTCHs that are scheduled. For each MTCH, an LCID field and a stop MTCH field may be included in the MSI MAC-CE. The LCID field indicates the logical channel ID of the MTCH. The length of the field may be 5 bits, for example. The “stop MTCH” field indicates the ordinal number of the subframe within the MCH scheduling period, e.g., counting the subframes allocated to the MCH, where the corresponding MTCH stops. A value 0 may correspond to the first subframe, for example. The length of the field may be 11 bits, for example. A special Stop MTCH value (e.g., such as 2047) may be used to indicate that the corresponding MTCH is not scheduled. Some of the value range, such as 2043 to 2046, may be reserved.

TABLE 2

| Index | LCID values |
|---|---|
| 00000 | MCCH (see note) |
| 00001- | MTCH |
| 11100 | |
| 11101 | Reserved |
| 11110 | MCH Scheduling Information or |
| | Extended MCH Scheduling Information |
| 11111 | Padding |

NOTE:
If there is no MCCH on MCH, an MTCH could use this value.

An MTCH may also be referred to as a “session” or a “MCH session.” Based on the MSI MAC-CE 540, the timing for the first MTCH (e.g., the first session in a session-list scheduled by the MSI MAC-CE) is not indicated and is assumed to start immediately after the MSI MAC-CE. As well, based on the MSI MAC-CE 540, the stopping subframe for each MTCH that is scheduled by the MSI lies within the MCH scheduling period, e.g., without a remaining portion of MTCH that spills over and is transmitted in the next MCH scheduling period. Stated otherwise, the entire set of subframes (with the corresponding MTCHs occurring back-to-back) scheduled by the MSI MAC-CE 540 are self-contained within a single MCH scheduling period. As well, the MSI periodicity may be based on (or indicated with reference to) a set of periods that are defined in a wireless standard, and to allow for co-existence between legacy and new services, the periodicity may not be arbitrary. As an example, the MCH scheduling period may be configured, or enumerated, with reference to a set of defined periods, such as rf1, rf2, rf4, rf8, rf16, rf32, rf64, rf128, rf256, rf512, and rf1024, e.g., where rf1 corresponds to one radio frame, rf2 corresponds to 2 radio frames, rf4 corresponds to 4 radio frames, rf 8 corresponds to 8 radio frames, rf 16 corresponds to 16 radio frames, and so forth.

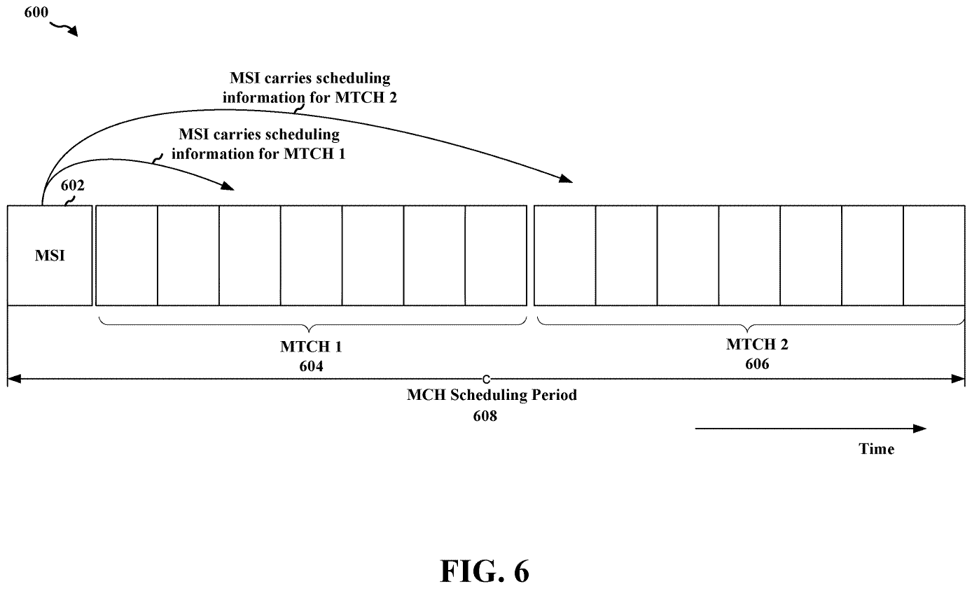

FIG. 6 illustrates an example time diagram 600 showing an MCH scheduling period 608. The network node transmits MSI 602 (e.g., in an MSI MAC-CE, such as 540) at the beginning of the MCH scheduling period 608. The MSI 602 carries scheduling information for one or more MTCHs (e.g., MTCH 1 604 and MTCH 2 606) in the MCH scheduling period 608, e.g., as described in connection with the fields of the MSI MAC-CE 540 in FIG. 5C.

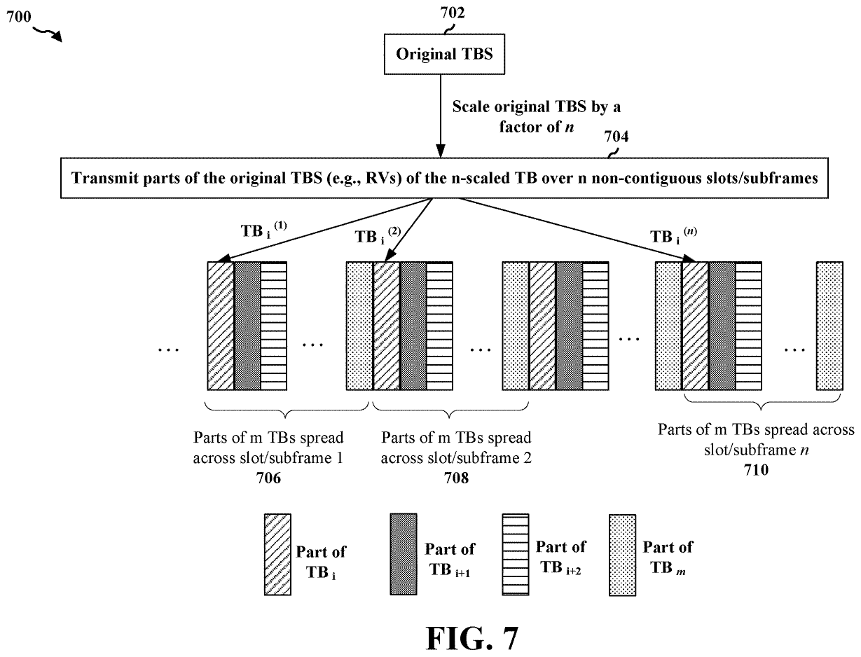

In some aspects, time-interleaving may be used for the transmission of the MTCHs. For each MTCH, several TBs (e.g., a total of m TBs, where m is a positive integer number) may be time-interleaved. Each of these interleaved TBs may occupy n non-contiguous slots/subframes, where n is a positive integer number. FIG. 7 illustrates a diagram 700 showing an original set of TBs 702 that is scaled by a factor of n, e.g., based on the n time periods (e.g., n slots or n subframes across which the TBs will be interleaved). Then, parts or portions of the original TBs are interleaved or mapped over n non-contiguous time periods (e.g., n non-contiguous slots or n non-contiguous subframes), at 704, based on the scaling. FIG. 7 shows that for the set of m TBs, a first part of the m TBs is spread across, e.g., mapped to, the first time period 706. A second part of the m TBs is spread across, e.g., mapped to, the second time period 708. The mapping continues until an n^{th} part of the m TBs is spread across, e.g., mapped to, the n^{th} time period 710. FIG. 7 also shows that for a particular TB, e.g., TBᵢ, where i identifies a particular TB from the original set of TBs 702, portions of the TBᵢ are interleaved with portions of the other TBs across the n time periods. In FIG. 7, TBᵢ⁽¹⁾ represents a first portion of TBᵢ that is transmitted in the first time period (e.g., first slot of subframe), TBᵢ⁽²⁾ represents a second portion of TBᵢ that is transmitted in the second time period, and TBᵢ⁽³⁾ represents a third portion of TB; that is transmitted in the third time period. In some aspects, the parts may be redundancy versions (RVs) of the TB.

For each MTCH, to schedule m TBs with time-interleaving, with each TB spanning n slots/subframes, a unit of m×n slots/subframes is used for scheduling. In some aspects, particular values of n may be more practical. For example, in some aspects, n may be equal to the number of redundancy versions (RVs) supported. As an example, if 4 RVs are supported, n may be 4. In some aspects, e.g., based on complexity constraints, limited values of m may be supportable (e.g., m=8, 16, 32) among other examples.

In some aspects, the combination of m×n may not divide the MCH periodicity equally. For example, if there are three MTCHs being scheduled by an MSI, and each MTCH is time-interleaved with m=16, n=4 (e.g., 16 TBs to be interleaved across 4 slots or subframes) leads to m×n=64. For an MCH scheduling period of rf32, e.g., 320 ms, the value of m×n=64 divides 320 ms, the scheduling period cannot be divided equally for 3 MTCHs (e.g., 3 MTCHs×64 ms/MTCH=192 ms does not divide the MCH scheduling periodicity of 320 ms). Similarly, for an MCH scheduling period of rf16, e.g., 160 ms, does not cannot accommodate the three MTCHs (e.g., 3 MTCHs×64 ms/MTCH=192 ms does not divide the MCH scheduling periodicity of 160 ms). The example of 192 ms may not divide any of the MCH periodicities needed to accommodate the three interleaved MTCHs. Expanded scheduling flexibility can be facilitated by the MSI to enable more flexible time-interleaving scenarios.

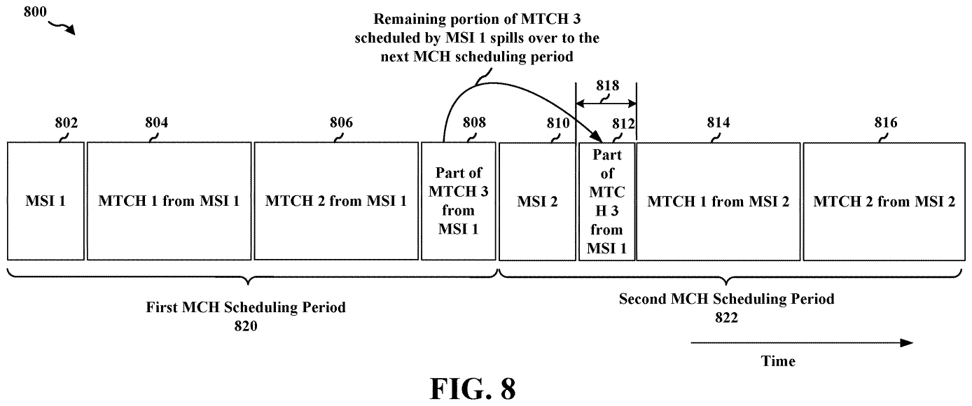

As described herein, an MSI MAC-CE can be used for time-interleaved MTCH transmission/reception that allows spillover of one or more MTCHs from one MCH scheduling period to the next (e.g., transmission of one or more MTCHs in a different MCH scheduling period from the MSI that initially scheduled the one or more MTCHs). In the example where an MCH scheduling period is rf16, e.g., 160 ms, for 3 MTCHs×64 ms/MTCH=192 ms, a remaining portion of the last MTCH may correspond to 32 ms (e.g., 192−160=32 ms) of the last MTCH remains after the 160 ms scheduling period. The remaining portion may be referred to as a remainder, an overflow, a spill over, among other example terms. The remaining portion may overflow or spill over from one MCH scheduling period to the next (e.g., may be scheduled in one MSI in MCH scheduling period and finish transmission in a following MCH scheduling period). The mapping of the remaining portion or spillover avoids the MSI (and MCCH) slots/subframes in the next MCH scheduling period. For example, FIG. 8 illustrates a time diagram 800 showing an example of a first MCH scheduling period 820 in which a first MSI 802 is transmitted and schedules MTCH 1, MTCH 2, and MTCH 3 (e.g., 804, 806, 808 and 810). The MTCH 1 transmission 804, which is scheduled by the first MSI 802, is transmitted after (e.g., immediately after or without a separating transmission from the first MSI 802). The MTCH 2 transmission 806, which is scheduled by the first MSI 802, is transmitted after the MTCH 1 transmission 804. A first portion of the MTCH 3 transmission 808, which is scheduled by the first MSI 802, is transmitted after the MTCH 2 transmission 806, but is not finished before the end of the first MCH scheduling period 820. The remaining portion of the MTCH 3 transmission 812, which is scheduled by the first MSI 802, may then be transmitted in the second MCH scheduling period 822. The second part of the MTCH 3 transmission 812 may be referred to as a remainder, a spill over, or an overflow of the MTCH 3 transmission that was scheduled by the first MSI 802. In some aspects, the remaining portion of the MTCH 3, or the spill over, may be referred to as an MTCH that is not self-contained within the MCH scheduling period (e.g., 820) in which the MTCH was scheduled (e.g., by the first MSI 802). As illustrated in FIG. 8, the remaining portion of the MTCH 3 transmission 812 avoids (does not overlap with) the resource for the second MSI 810 that schedules MCH traffic in the second MCH scheduling period 822. The remaining portion of the MTCH 3 transmission 812 is transmitted after the second MSI 810 for the second MCH scheduling period 822.

The second MSI 810 schedules MTCH transmissions in the second MCH scheduling period 822, e.g., MTCH 1 and MTCH 2 (e.g., 814 and 816). Where the first MTCH (e.g., 804) scheduled by the first MSI 802 occurs directly after the first MSI 802, in the second MCH scheduling period, the first MTCH (e.g., 814) is spaced from the second MSI 810 by a time gap 818, which may be referred to as a start offset. An MSI may include information about such a start offset (e.g., time gap 818) to enable receivers (e.g., UEs) to determine when a first MTCH scheduled by the MSI will start. Based on that information, and the information that the MSI includes about the stop points for the scheduled MTCHs enables a UE receiving the MSI to determine when the various scheduled MTCHs will start and stop. For example, by determining when the MTCH 1 transmission 814 scheduled by the second MSI 810 will start and stop, the UE may determine the starting point for the MTCH 2 transmission 816 scheduled by the second MSI 810. For example, an MSI may indicate a starting pointer or start offset within an MCH period, for one or more MTCHs scheduled by the MSI.

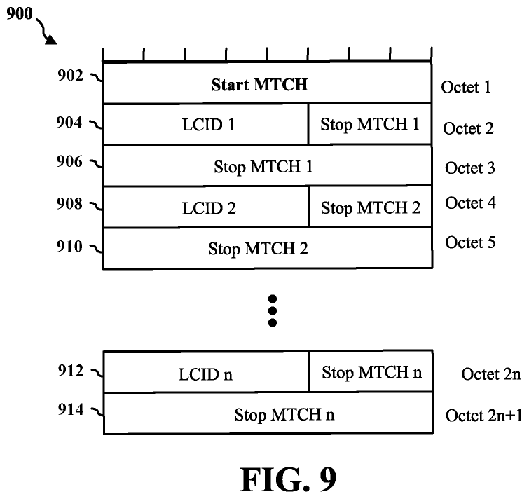

FIG. 9 illustrates aspects of an example MSI MAC-CE 900 that includes scheduling information for one or more MTCHs and information about a starting offset that enables spillover of remaining MTCH transmission from a prior MCH scheduling period. The MSI MAC-CE 900 may be identified by a MAC PDU subheader with a LCID, e.g., as described in connection with FIG. 5C. This control element has a variable size, e.g., based on the number n of MTCHs that are scheduled. For each MTCH, an LCID field (e.g., 904, 908, 912) and a stop MTCH field (e.g., 906, 910, and 914), e.g., as described in connection with the MSI MAC-CE 540 in FIG. 5C. In contrast to the MSI MAC-CE 540 in FIG. 5C, the MSI MAC-CE in FIG. 9 further includes, at 902, an indication of the starting point of the first scheduled MTCH (e.g., MTCH 1 scheduled by the MSI MAC-CE). The indication at 902 may be a field that indicates a start offset between the MSI and MAC-CE and the start of the first MTCH (e.g., MTCH 1 scheduled by the MSI MAC-CE). The indication may be referred to as a start pointer, start offset indication, or start offset field, among other examples. The indication of the start offset accommodates the spillover of MTCH transmissions from the previous MCH scheduling period, e.g., as described in connection with FIG. 8. A UE that receives the MSI will not know when the next MTCH starts in the MCH scheduling until the UE has decoded the MSI and determines the time offset indication. The MTCH may be time-interleaved, e.g., as described in connection with FIG. 7.

If different MTCHs, e.g., different sessions, have different time-interleaving parameters (e.g., different m, n), the UE does not de-rate-match the received subframes prior to the time that the UE finishes the MSI decoding. For example, the UE decodes the MSI to determine whether there is a different m, n, and until the UE knows the m, n, the UE is not able to accurately de-rate-match the received subframes.

In this example, the UE may buffer the pre-de-rate-matched data (e.g., the data received from MTCHs received prior to the decoding of the MSI for the MCH scheduling period), which involves additional complexity at the UE.

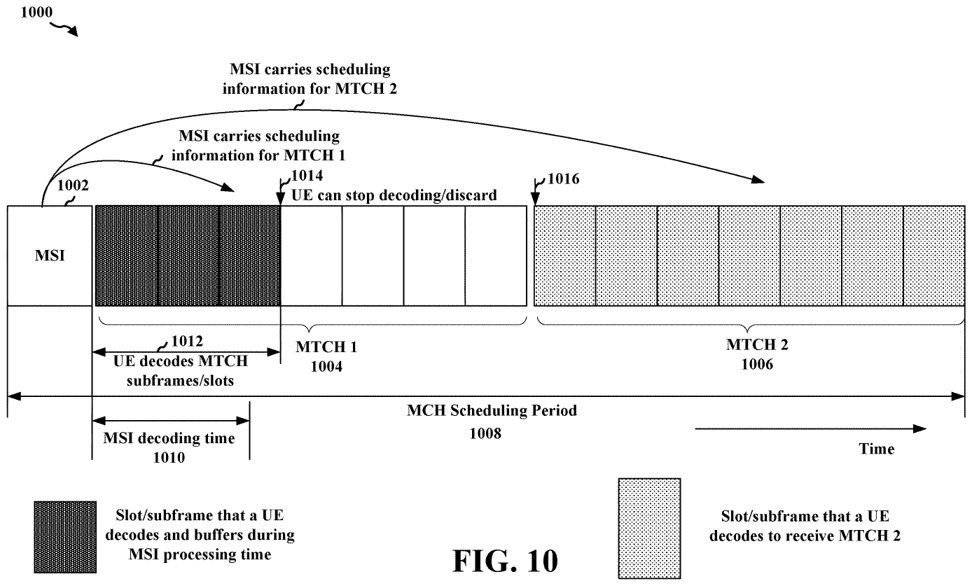

With respect to MTCHs scheduled by an MSI without spillover (e.g., which may be referred to as a legacy MSI in some aspects), the MSI does not include a start offset indication or start pointer, and the MTCHs start immediately after, e.g., directly after, the MSI without a start offset. For example, the MSI may be similar to the example in FIG. 5C rather than the example in FIG. 9. With an MSI without a start offset indication (e.g., a legacy MSI), each MTCH subframe is self-decodable. For example, for a time-interleaved MTCH, the UE is able to decode the MTCH after (e.g., and not before) an full m×n subframe chunk of corresponding time-interleaved TBs are received. As the physical (PHY) layer parameters are the same for the sessions (e.g., MTCHs), the UE can de-rate-match the received subframes. FIG. 10 illustrates an example timeline 1000 showing an MSI 1002 that schedules MTCH 1 1004 and MTCH 2 1006 in an MCH scheduling period 1008. At 1010, a processing time, or decoding time, is shown following the MSI 1002 for the UE to processing the MSI MAC-CE and determine the scheduling information for the scheduled MTCHs in the MCH scheduling period 1008. Prior to finishing the processing of the MSI, e.g., for slots or subframes that overlap with the MSI decoding time 1010, the UE decodes the received MTCH 1 1004, as shown for the time period 1012, and buffers the decoded data. Once the MSI is decoded, the UE may determine whether or not to continue to receive the MTCH 1 1004. If the UE is instead attempting to receive the MTCH 2 1006, the UE may stop decoding the MTCH 1 at the time 1014. The UE may discard the previously decoded and buffered portion of the MTCH 1. For example, the UE decodes (e.g., subframe-by-subframe or slot-by-slot) the MTCH subframes/slots during the time period 1012, e.g., even if the MTCH 1 1004 is not of interest to the UE. The decoding stops at 1014, once the UE determines (e.g., from the MSI payload) that the service of interest (e.g., MTCH 2) starts later, e.g., at 1016.

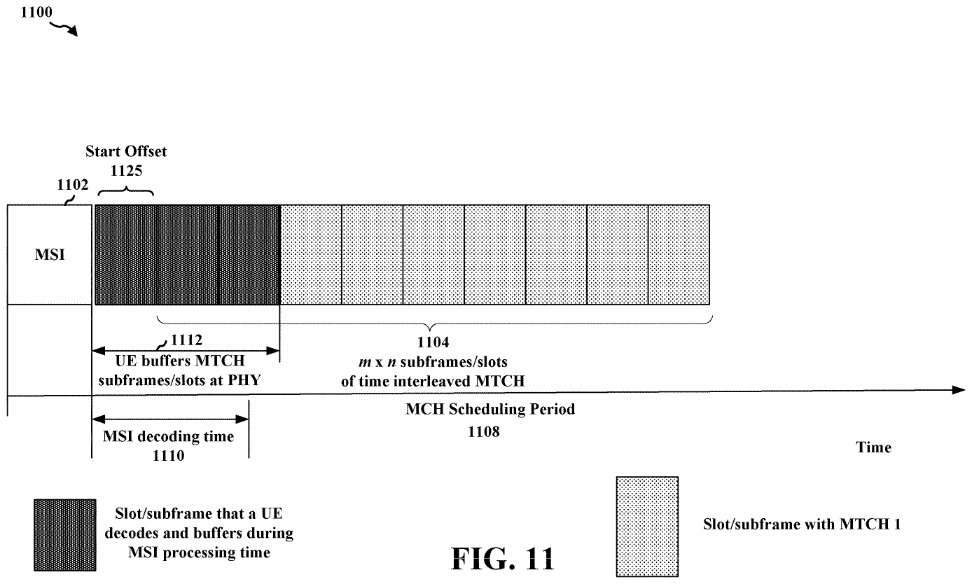

Further complexity is experienced at the UE if there may be time-interleaving of the MTCH TBs. FIG. 11 illustrates an example timeline 1100 for MCH processing similar to FIG. 10. However, in FIG. 11, there is a start offset 1125 between the MSI 1102 and the MTCH scheduled by the MSI 1102 in the MCH scheduling period 1108. The start offset 1125 is based on a remaining portion of an MTCH scheduled in the prior MCH scheduling period. As with FIG. 10, the UE buffers the data received in the subframes/slots 1112 during the time that the UE decodes the MSI, e.g., 1110.

In FIG. 11, the MTCH scheduled by the MSI 1102 includes m×n subframes or slots of time interleaved MTCH 1104 (e.g., similar to the time-interleaved MTCH described in connection with FIG. 7). The UE buffers each of the subframes/slots until the MSI decoding is complete, as these subframes/slots can be part of the m×n group of interleaved MTCH, based on the start point of the MTCH for the MCH scheduling period. These MTCH received during the subframes/slots before the UE finishes decoding the MSI are buffered at PHY level (e.g., before de-rate-matching the data, which may be referred to as “pre-de-rate-matched” data). The UE stores the received data from the MTCH received during the MSI processing time at the PHY level without decoding or de-rate-matching because different sessions (e.g., different MTCHs) can have different values of m, n). For example, the remaining MTCH scheduled in the prior MCH scheduling period may have a different value of m, n than the MTCH scheduled by the MSI 1102 in the MCH scheduling period 1108. MTCH received during the MSI processing time is not self-decodable, because it may be part of an m×n time-interleaved block.

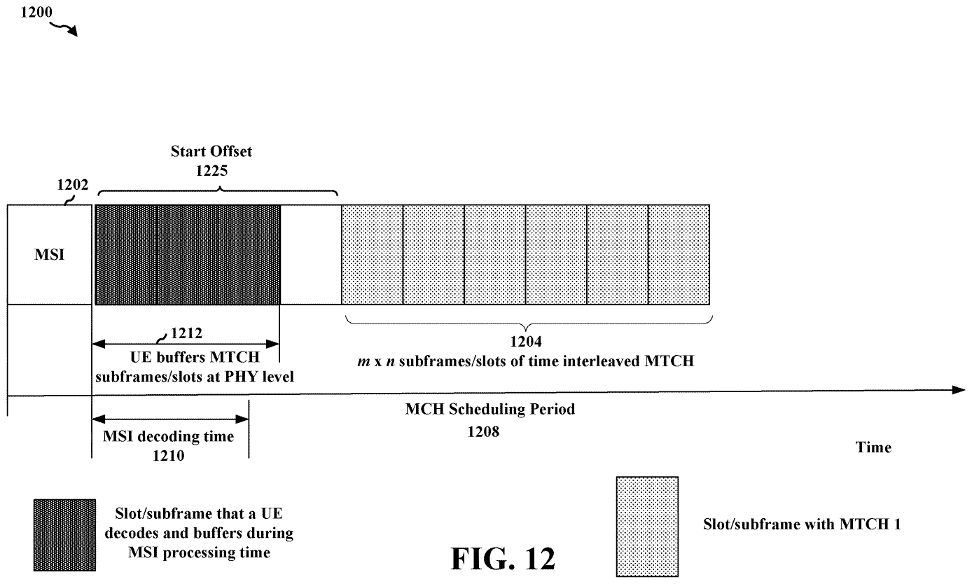

FIG. 12 illustrates an example 1200 that is similar to FIG. 11, but including a longer start offset 1225 that extends beyond the MSI decoding time 1210 to decode the MSI 1202. In this example, the UE buffers the MTCH received in the subframes/slots at 1212 at PHY layer (e.g., as pre-de-rate-matched data, due to the potential that different sessions (e.g., MTCHs) have different values of m, n), as these subframes/slots of the MTCH are not self-decodable, but may be part of a m×n time-interleaved block. In the example in FIG. 12, the buffering is wasted if the UE is not interested in the MTCH carried over from the prior MCH scheduling period before the MCH scheduling period 1208. For example, the buffering is wasted because the m×n block of time interleaved MTCH 1204 starts after the processing period for MSI, at 1210.

As presented herein, a minimum time gap can be used before the first MTCH is scheduled by an MSI in a MCH scheduling period. In some aspects, the minimum time gap can be used before the first time-interleaved MTCH scheduled by an MSI in an MCH scheduling period. In other aspects, the minimum time gap can be used before the first MTCH scheduled by an MSI in an MCH scheduling period, where the first MTCH is non-time-interleaved. The use of the minimum time gap can help the UE to avoid buffering during the MSI processing time and/or to avoid buffering at a PHY level during the MSI processing time. The use of the minimum time gap also provides a power savings benefit for non-time-interleaved MTCHs, e.g., when the MTCH immediately following the MSI is not an MTCH of interest to the UE.

For a time-interleaved PMCH transmission, the minimum time gap (e.g., the start point offset) based on:

$$Start point offset = max \{ {T}_{p r o c} , {T}_{s p i l l o v e r} \}$$

In this example, T_{proc} denotes a time for the UE to process the MSI, and Tₛₚᵢₗₗₒᵥₑᵣ denotes a time for the transmission of the remaining MTCH from the prior MCH scheduling period that spills over to transmission in the current MCH scheduling period. Among other example values, T_{proc} may be between 1-5 ms, such as 2 or 3 milliseconds. In some aspects, the value for T_{proc} may be defined, e.g., in a wireless standard, and known by the UE and the network node without additional signaling to inform each other of the value. In other aspects, the network node may configure the value of T_{proc}, and transmit the configuration, which is received by the UE.

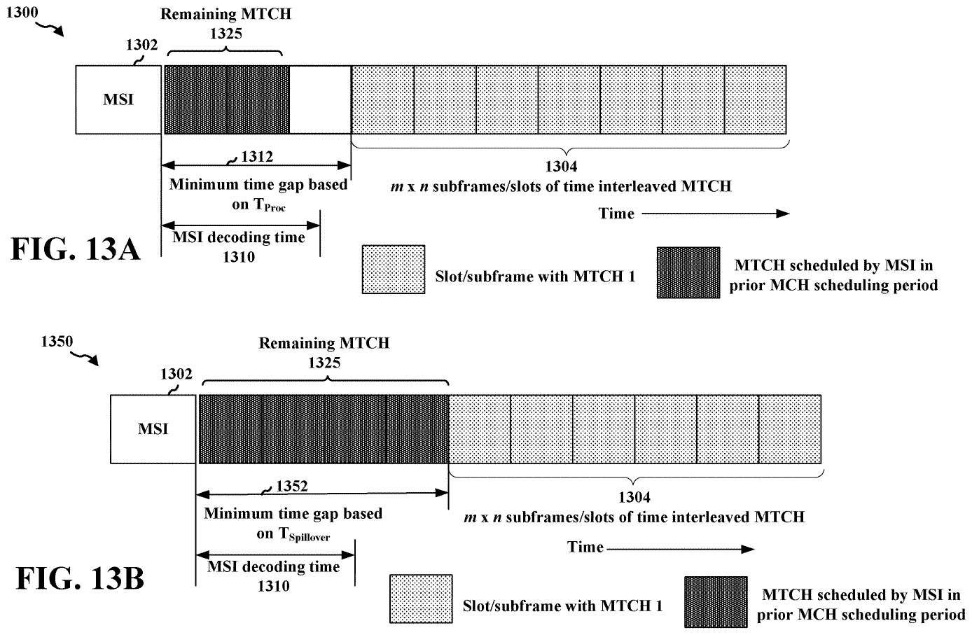

FIG. 13A and FIG. 13B illustrate examples of a starting point offset that is based on a maximum between T_{proc} and Tₛₚᵢₗₗₒᵥₑᵣ. In FIGS. 13A and 13B, T_{proc} is 3 subframes or 3 slots. In FIG. 13A, the example timeline 1300 shows that Tₛₚᵢₗₗₒᵥₑᵣ is 2 subframes or 2 slots, at 1325. As between T_{proc}>Tₛₚᵢₗₗₒᵥₑᵣ, the minimum time gap 1312 between the MSI 1302 and the first scheduled MTCH 1304 is based on T_{proc}. As illustrated at 1310, the T_{proc} accounts for, or is based on, a processing time for the UE to decode the MSI 1302. In contrast to FIG. 13A, in FIG. 13B, the example timeline 1350 shows that T_{proc}<Tₛₚᵢₗₗₒᵥₑᵣ, because the remaining MTCH 1325 spans 4 subframes or slots. In this example, the minimum time gap 1352 is based on Tₛₚᵢₗₗₒᵥₑᵣ.

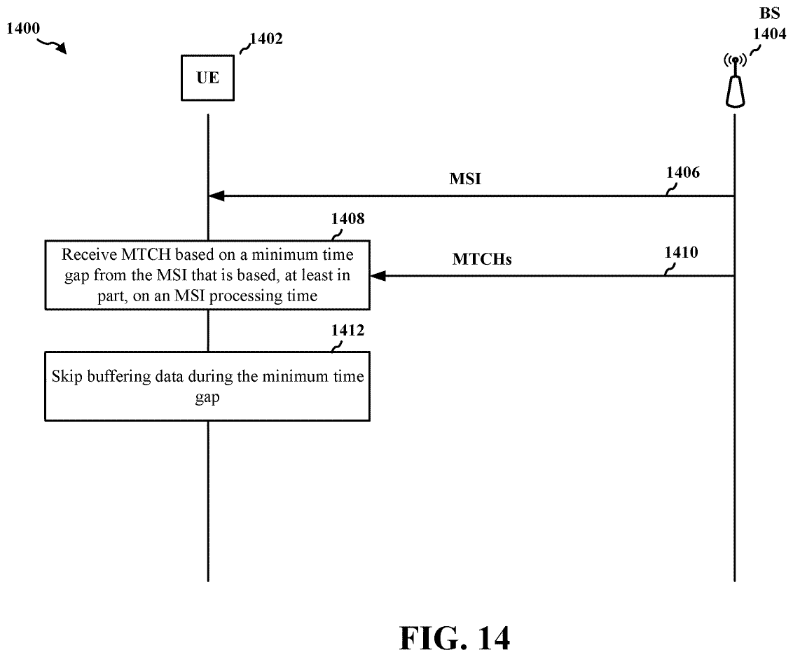

FIG. 14 illustrates an example communication flow 1400 between a UE 1402 and a network node 1404. In some aspects, the aspects performed by the network node 1404 may be performed by a base station in aggregation. In other aspects, the aspects performed by the network node 1404 may be performed by one or more components of a disaggregated base station such as a CU, DU, and/or RU. Although only a single UE is shown in FIG. 14 to illustrate the concept, multiple UEs may receive the MBMS communication from the network node. Various UEs may be interested in different MTCHs. Therefore, a particular UE may use the scheduling information received from the network node to receive the MTCH of interest for that particular UE. The aspects performed by the UE in FIG. 14 may be performed by any of multiple UEs served by the network node.

The network node 1404 transmits MBMS communication, e.g., including multiple MTCH transmissions. At 1406, the network node 1404 transmits MSI, e.g., such as an MSI MAC-CE that schedules multiple MTCH transmissions in an MCH scheduling period. In some aspects, the multiple MTCH transmissions may include at least one MTCH transmission that is time-interleaved, such as described in connection with FIG. 7. The MSI MAC-CE may include any of the aspects described in connection with FIG. 5C and/or FIG. 9, for example. The network node 1404 may multicast or broadcast the MSI MAC-CE, for example.

At 1410, the network node 1404 transmits the scheduled MTCH transmissions, e.g., which may also be referred to as sessions. The UE 1402 receives the MSI, at 1406, and uses information in the MSI to receive at least one of the scheduled MTCHs during the MCH scheduling period, as shown at 1408. The reception may include any of the aspects described in connection with FIG. 5A-13, for example. For example, the reception at 1408 may be based on scheduling information in the MSI MAC-CE and a scheduling delay between the MSI MAC-CE and a first MTCH transmission of the multiple MTCH transmissions that is based at least in part on a threshold time gap. the threshold time gap includes a minimum time gap between the MSI MAC-CE and the first MTCH transmission scheduled by the MSI MAC-CE. The threshold time gap may be based on a processing time threshold (e.g., T_{proc}), e.g., for UEs to process the MSI. In some aspects, the processing time threshold may have a defined value, e.g., defined in a wireless standard. In some aspects, the processing time threshold may be configured by the network node and signaled to UEs receiving the MBMS communication. The scheduling delay between the MSI MAC-CE and the first MTCH transmission scheduled by the MSI MAC-CE may be further based on an amount of remaining MTCH transmission that was scheduled by a prior MSI MAC-CE (e.g., Tₛₚᵢₗₗₒᵥₑᵣ). For example, the scheduling delay may be based on one of: the threshold time gap, if the threshold time gap is larger than a time for the remaining MTCH transmission that was scheduled by the prior MSI MAC-CE, or the time for the remaining MTCH transmission that was scheduled by a prior MSI MAC-CE, if the threshold time gap is not larger than the time for the remaining MTCH transmission that was scheduled by the prior MSI MAC-CE. For example the scheduling delay may be based on a minimum time gap represented as a start point offset=max {T_{proc}, Tₛₚᵢₗₗₒᵥₑᵣ}.

As shown at 1412, the UE 1402 may skip buffering of the data received during the minimum time gap, e.g., as described in connection with FIGS. 13A and 13B.

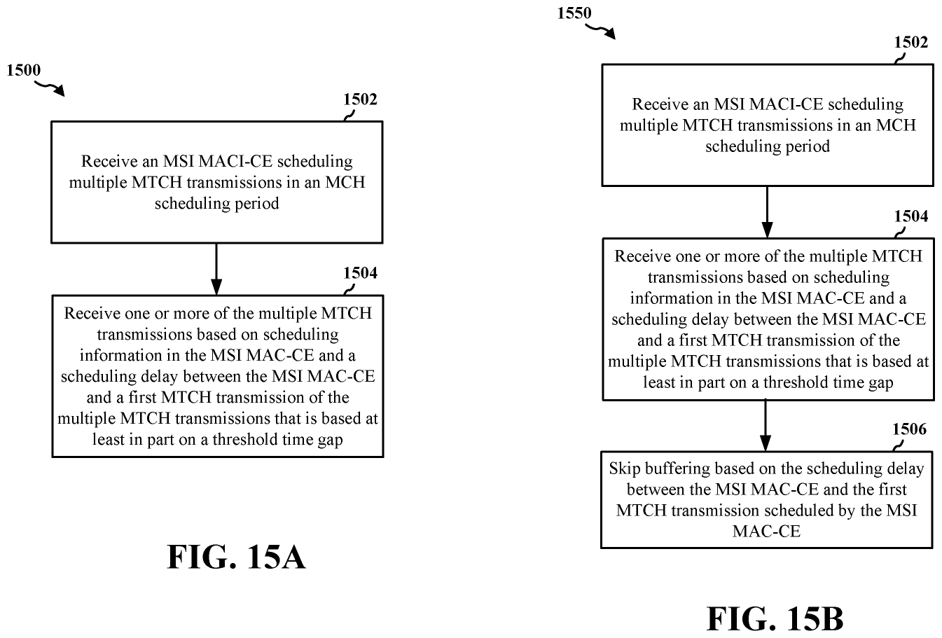

FIG. 15A is a flowchart 1500 of a method of wireless communication. The method may be performed by a UE (e.g., the UE 104, 450, 1402; the apparatus 1704). The method helps to save power and reduce complexity at the UE by enabling the UE to avoid decoding, buffering, and/or buffering non-de-rate-matched data while the UE processes an MSI to determine scheduling information for one or more MTCHs of interest to the UE. By reducing the buffering at the UE, the UE saves power and the UE's reception of the intended MTCH is simplified.

At 1502, the UE receives a MSI MAC-CE scheduling multiple MTCH transmissions in an MCH scheduling period. FIGS. 5C and FIG. 9 illustrate example aspects of an MSI MAC-CE that schedules MTCH transmissions. FIGs. The communication may include any of the aspects described in connection with FIGS. 5A-14, for example. The reception may be performed by one or more of the MCH component 198, the transceiver(s) 1722, and/or antenna(s) 1780, for example.

At 1504, the UE receives one or more of the multiple MTCH transmissions based on scheduling information in the MSI MAC-CE and a scheduling delay between the MSI MAC-CE and a first MTCH transmission of the multiple MTCH transmissions that is based at least in part on a threshold time gap. FIGS. 13A, 13B, and 14 illustrate examples of a UE receiving an MTCH transmission based on a threshold time gap between the MSI and the MTCH transmission. The threshold time gap may include a minimum time gap between the MSI MAC-CE and the first MTCH transmission scheduled by the MSI MAC-CE, for example. The threshold time gap may correspond to a processing time threshold (e.g., T_{proc}), for example. In some aspects, the processing time threshold may have a defined value, e.g., defined in a wireless standard. In some aspects, the processing time threshold may be configured by the network node and received by the UE in signaling from the network node. In some aspects, the scheduling delay between the MSI MAC-CE and the first MTCH transmission scheduled by the MSI MAC-CE may be further based on an amount of remaining MTCH transmission (e.g., Tₛₚᵢₗₗₒᵥₑᵣ) that was scheduled by a prior MSI MAC-CE. For example, the scheduling delay may be based on one of: the threshold time gap, if the threshold time gap is larger than a time for the remaining MTCH transmission that was scheduled by the prior MSI MAC-CE, or the time for the remaining MTCH transmission that was scheduled by a prior MSI MAC-CE, if the threshold time gap is not larger than the time for the remaining MTCH transmission that was scheduled by the prior MSI MAC-CE. For example the scheduling delay may be based on a minimum time gap represented as a start point offset=max {T_{proc}, Tₛₚᵢₗₗₒᵥₑᵣ}. The reception may be performed by one or more of the MCH component 198, the transceiver(s) 1722, and/or antenna(s) 1780, for example.

In some aspects, the multiple MTCH transmissions may include at least one time-interleaved MTCH transmission. FIG. 7 illustrates example aspects of time-interleaved MTCH TBs. In some aspects, the UE may skip buffering based on the scheduling delay between the MSI MAC-CE and the first MTCH transmission scheduled by the MSI MAC-CE. The skipping may be performed by the MCH component 198, for example.

FIG. 15B is a flowchart 1550 of a method of wireless communication. The method may be performed by a UE (e.g., the UE 104, 450, 1402; the apparatus 1704). The method helps to save power and reduce complexity at the UE by enabling the UE to avoid decoding, buffering, and/or buffering non-de-rate-matched data while the UE processes an MSI to determine scheduling information for one or more MTCHs of interest to the UE. By reducing the buffering at the UE, the UE saves power and the UE's reception of the intended MTCH is simplified.

At 1502, the UE receives a MSI MAC-CE scheduling multiple MTCH transmissions in an MCH scheduling period. FIGS. 5C and FIG. 9 illustrate example aspects of an MSI MAC-CE that schedules MTCH transmissions. FIGs. The communication may include any of the aspects described in connection with FIGS. 5A-14, for example. The reception may be performed by one or more of the MCH component 198, the transceiver(s) 1722, and/or antenna(s) 1780, for example.

At 1504, the UE receives one or more of the multiple MTCH transmissions based on scheduling information in the MSI MAC-CE and a scheduling delay between the MSI MAC-CE and a first MTCH transmission of the multiple MTCH transmissions that is based at least in part on a threshold time gap. FIGS. 13A, 13B, and 14 illustrate examples of a UE receiving an MTCH transmission based on a threshold time gap between the MSI and the MTCH transmission. The threshold time gap may include a minimum time gap between the MSI MAC-CE and the first MTCH transmission scheduled by the MSI MAC-CE, for example. The threshold time gap may correspond to a processing time threshold (e.g., T_{proc}), for example. In some aspects, the processing time threshold may have a defined value, e.g., defined in a wireless standard. In some aspects, the processing time threshold may be configured by the network node and received by the UE in signaling from the network node. In some aspects, the scheduling delay between the MSI MAC-CE and the first MTCH transmission scheduled by the MSI MAC-CE may be further based on an amount of remaining MTCH transmission (e.g., Tₛₚᵢₗₗₒᵥₑᵣ) that was scheduled by a prior MSI MAC-CE. For example, the scheduling delay may be based on one of: the threshold time gap, if the threshold time gap is larger than a time for the remaining MTCH transmission that was scheduled by the prior MSI MAC-CE, or the time for the remaining MTCH transmission that was scheduled by a prior MSI MAC-CE, if the threshold time gap is not larger than the time for the remaining MTCH transmission that was scheduled by the prior MSI MAC-CE. For example the scheduling delay may be based on a minimum time gap represented as a start point offset=max {T_{proc}, Tₛₚᵢₗₗₒᵥₑᵣ}. The reception may be performed by one or more of the MCH component 198, the transceiver(s) 1722, and/or antenna(s) 1780, for example. In some aspects, the multiple MTCH transmissions may include at least one time-interleaved MTCH transmission. FIG. 7 illustrates example aspects of time-interleaved MTCH TBs.

At 1506, the UE skips buffering based on the scheduling delay between the MSI MAC-CE and the first MTCH transmission scheduled by the MSI MAC-CE. The skipping may be performed by the MCH component 198, for example. FIG. 14 illustrates an example of a UE skipping buffering data during the minimum time gap.

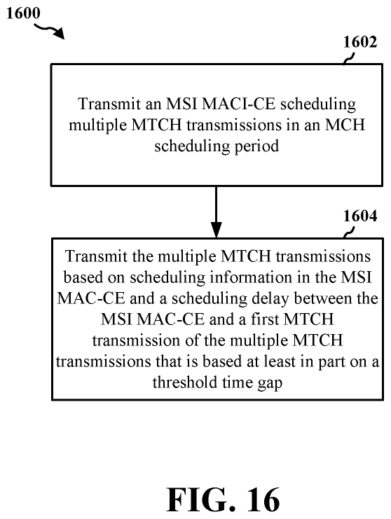

FIG. 16 is a flowchart 1600 of a method of wireless communication. The method may be performed by a network node (e.g., the base station 102, 410; the CU 110; the DU 130; the RU 140; the network node 1404; the network entity 1802). As an example, the method may be performed by a base station in aggregation or by one or more components of a disaggregated base station such as a CU, DU, and/or RU. The method enables the network node to assist the UE in saving power and enables reduced complexity for UEs served by the network node by enabling the UEs to skip decoding, buffering, and/or buffering non-de-rate-matched data while the UEs process an MSI to determine scheduling information for one or more MTCHs of interest to the respective UEs.

At 1602, the network node transmits an MSI MAC-CE scheduling multiple MTCH transmissions in an MCH scheduling period. FIGS. 5C and FIG. 9 illustrate example aspects of an MSI MAC-CE that schedules MTCH transmissions. The communication may include any of the aspects described in connection with FIGS. 5A-14, for example. The transmission may be performed by one or more of the MCH component 199, the transceiver(s) 1846, and/or antenna(s) 1880, for example.

At 1604, the network node transmits the multiple MTCH transmissions based on scheduling information in the MSI MAC-CE and a scheduling delay between the MSI MAC-CE and a first MTCH transmission of the multiple MTCH transmissions that is based at least in part on a threshold time gap. FIGS. 13A, 13B, and 14 illustrate examples of a network node transmitting MTCH transmissions based on a threshold time gap between the MSI and a first scheduled MTCH transmission. The threshold time gap may include a minimum time gap between the MSI MAC-CE and the first MTCH transmission scheduled by the MSI MAC-CE, for example. The threshold time gap may correspond to a processing time threshold (e.g., T_{proc}), for example. In some aspects, the processing time threshold may have a defined value, e.g., defined in a wireless standard. In some aspects, the processing time threshold may be configured by the network node and signaled to the UEs by the network node. In some aspects, the scheduling delay between the MSI MAC-CE and the first MTCH transmission scheduled by the MSI MAC-CE may be further based on an amount of remaining MTCH transmission (e.g., Tₛₚᵢₗₗₒᵥₑᵣ) that was scheduled by a prior MSI MAC-CE. For example, the scheduling delay may be based on one of: the threshold time gap, if the threshold time gap is larger than a time for the remaining MTCH transmission that was scheduled by the prior MSI MAC-CE, or the time for the remaining MTCH transmission that was scheduled by a prior MSI MAC-CE, if the threshold time gap is not larger than the time for the remaining MTCH transmission that was scheduled by the prior MSI MAC-CE. For example the scheduling delay may be based on a minimum time gap represented as a start point offset=max {T_{proc}, Tₛₚᵢₗₗₒᵥₑᵣ}. The transmission may be performed by one or more of the MCH component 199, the transceiver(s) 1846, and/or antenna(s) 1880, for example.

In some aspects, the multiple MTCH transmissions may include at least one time-interleaved MTCH transmission. FIG. 7 illustrates example aspects of time-interleaved MTCH TBs.

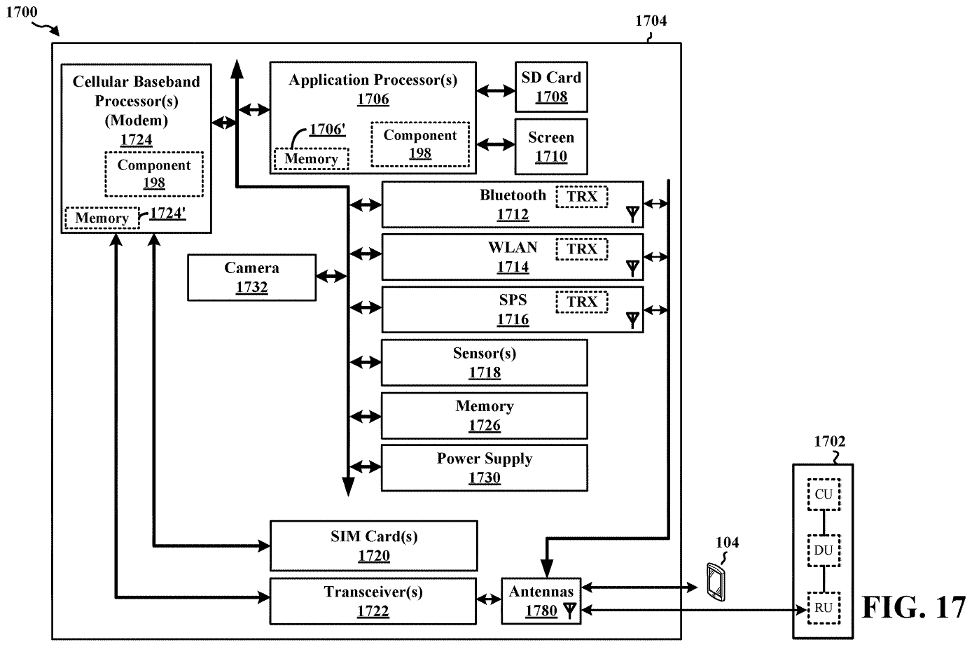

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include at least one cellular baseband processor 1724 (also referred to as a modem) coupled to one or more transceivers 1722 (e.g., cellular RF transceiver). The cellular baseband processor(s) 1724 may include at least one on-chip memory 1724′. In some aspects, the apparatus 1704 may further include one or more subscriber identity modules (SIM) cards 1720 and at least one application processor 1706 coupled to a secure digital (SD) card 1708 and a screen 1710. The application processor(s) 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor(s) 1724 communicates through the transceiver(s) 1722 via one or more antennas 1780 with the UE 104 and/or with an RU associated with a network entity 1702. The cellular baseband processor(s) 1724 and the application processor(s) 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor(s) 1724 and the application processor(s) 1706 are each responsible for general processing, including the execution of software stored on the computer-readable medium/memory. The software, when executed by the cellular baseband processor(s) 1724/application processor(s) 1706, causes the cellular baseband processor(s) 1724/application processor(s) 1706 to perform the various functions described supra. The cellular baseband processor(s) 1724 and the application processor(s) 1706 are configured to perform the various functions described supra based at least in part of the information stored in the memory. That is, the cellular baseband processor(s) 1724 and the application processor(s) 1706 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1724/application processor(s) 1706 when executing software. The cellular baseband processor(s) 1724/application processor(s) 1706 may be a component of the UE 450 and may include the at least one memory 460 and/or at least one of the TX processor 468, the RX processor 456, and the controller/processor 459. In one configuration, the apparatus 1704 may be at least one processor chip (modem and/or application) and include just the cellular baseband processor(s) 1724 and/or the application processor(s) 1706, and in another configuration, the apparatus 1704 may be the entire UE (e.g., see UE 450 of FIG. 4) and include the additional modules of the apparatus 1704.

As discussed supra, the component 198 may be configured to receive a multicast channel scheduling information (MSI) medium access control-control element (MAC-CE) scheduling multiple multicast traffic channel (MTCH) transmissions in a multicast channel (MCH) scheduling period; and receive one or more of the multiple MTCH transmissions based on scheduling information in the MSI MAC-CE and a scheduling delay between the MSI MAC-CE and a first MTCH transmission of the multiple MTCH transmissions that is based at least in part on a threshold time gap. In some aspects, the apparatus or the MCH component 198 may be further configured to skip buffering based on the scheduling delay between the MSI MAC-CE and the first MTCH transmission scheduled by the MSI MAC-CE. The apparatus 1704 may be further configured to perform any of the aspects described in connection with the flowchart in FIG. 15A and/or FIG. 15B, performed by the UE in FIG. 14, and/or described in connection with FIGS. 5A-13B. The component 198 may be within the cellular baseband processor(s) 1724, the application processor(s) 1706, or both the cellular baseband processor(s) 1724 and the application processor(s) 1706. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1704 may include a variety of components configured for various functions. In one configuration, the apparatus 1704, and in particular the cellular baseband processor(s) 1724 and/or the application processor(s) 1706, may include means for receiving a multicast channel scheduling information (MSI) medium access control-control element (MAC-CE) scheduling multiple multicast traffic channel (MTCH) transmissions in a multicast channel (MCH) scheduling period; and means for receiving one or more of the multiple MTCH transmissions based on scheduling information in the MSI MAC-CE and a scheduling delay between the MSI MAC-CE and a first MTCH transmission of the multiple MTCH transmissions that is based at least in part on a threshold time gap. In some aspects, the apparatus may further include means for skipping buffering based on the scheduling delay between the MSI MAC-CE and the first MTCH transmission scheduled by the MSI MAC-CE. The apparatus 1704 may further include means for performing any of the aspects described in connection with the flowchart in FIG. 15A and/or FIG. 15B, performed by the UE in FIG. 14, and/or described in connection with FIGS. 5A-13B. The means may be the component 198 of the apparatus 1704 configured to perform the functions recited by the means. As described supra, the apparatus 1704 may include the TX processor 468, the RX processor 456, and the controller/processor 459. As such, in one configuration, the means may be the TX processor 468, the RX processor 456, and/or the controller/processor 459 configured to perform the functions recited by the means.

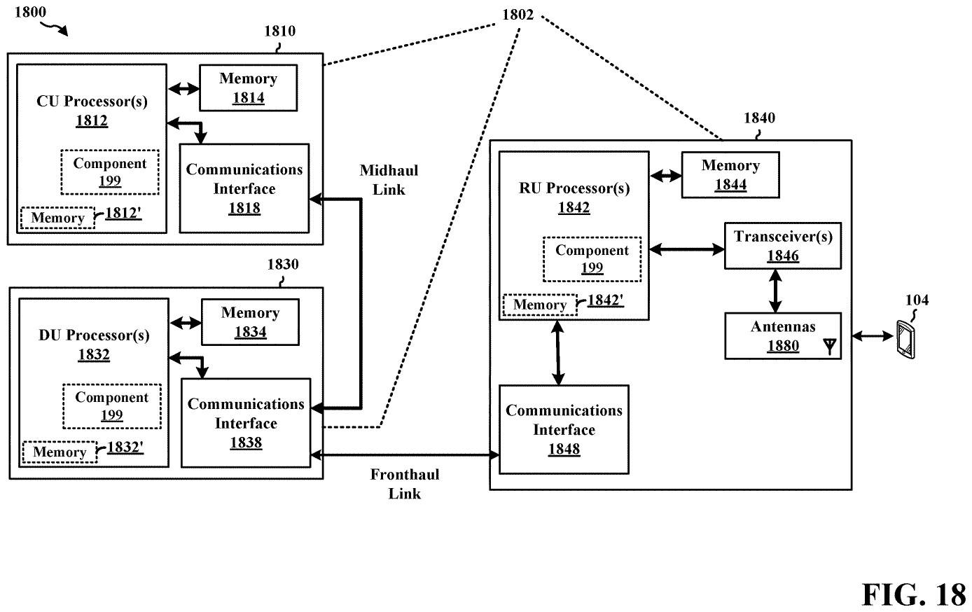

FIG. 18 is a diagram 1800 illustrating an example of a hardware implementation for a network entity 1802. The network entity 1802 may be a BS, a component of a BS, or may implement BS functionality. The network entity 1802 may include at least one of a CU 1810, a DU 1830, or an RU 1840. For example, depending on the layer functionality handled by the component 199, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include at least one CU processor 1812. The CU processor(s) 1812 may include on-chip memory 1812′. In some aspects, the CU 1810 may further include additional memory modules 1814 and a communications interface 1818. The CU 1810 communicates with the DU 1830 through a midhaul link, such as an F1 interface. The DU 1830 may include at least one DU processor 1832. The DU processor(s) 1832 may include on-chip memory 1832′. In some aspects, the DU 1830 may further include additional memory modules 1834 and a communications interface 1838. The DU 1830 communicates with the RU 1840 through a fronthaul link. The RU 1840 may include at least one RU processor 1842. The RU processor(s) 1842 may include on-chip memory 1842′. In some aspects, the RU 1840 may further include additional memory modules 1844, one or more transceivers 1846, antennas 1880, and a communications interface 1848. The RU 1840 communicates with the UE 104. The on-chip memory 1812′, 1832′, 1842′ and the additional memory modules 1814, 1834, 1844 may each be considered a computer-readable medium/memory. Each computer-readable medium/memory may be non-transitory. Each of the processors 1812, 1832, 1842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit a multicast channel scheduling information (MSI) medium access control-control element (MAC-CE) scheduling multiple multicast traffic channel (MTCH) transmissions in a multicast channel (MCH) scheduling period; and transmit the multiple MTCH transmissions based on scheduling information in the MSI MAC-CE and a scheduling delay between the MSI MAC-CE and a first MTCH transmission of the multiple MTCH transmissions that is based at least in part on a threshold time gap. The network entity 1802 may be further configured to perform any of the aspects described in connection with the flowchart in FIG. 16, performed by the network node in FIG. 14, and/or described in connection with FIGS. 5A-13B. The component 199 may be within one or more processors of one or more of the CU 1810, DU 1830, and the RU 1840. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1802 may include a variety of components configured for various functions. In one configuration, the network entity 1802 may include means for transmitting a multicast channel scheduling information (MSI) medium access control-control element (MAC-CE) scheduling multiple multicast traffic channel (MTCH) transmissions in a multicast channel (MCH) scheduling period; and means for transmitting the multiple MTCH transmissions based on scheduling information in the MSI MAC-CE and a scheduling delay between the MSI MAC-CE and a first MTCH transmission of the multiple MTCH transmissions that is based at least in part on a threshold time gap. The network entity 1802 may further include means for performing any of the aspects described in connection with the flowchart in FIG. 16, performed by the network node in FIG. 14, and/or described in connection with FIGS. 5A-13B The means may be the component 199 of the network entity 1802 configured to perform the functions recited by the means. As described supra, the network entity 1802 may include the TX processor 416, the RX processor 470, and the controller/processor 475. As such, in one configuration, the means may be the TX processor 416, the RX processor 470, and/or the controller/processor 475 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” or “based on or otherwise in association with” unless specifically recited differently. As used herein, the phrase “associated with” encompasses any association, relation, or connection link. Among other examples, the phrase “associated with” may include in association with, based on, based at least in part on, corresponding to, related to, in response to, linked with, and/or connected with. As used herein, “using” may include any use, which may include any consideration, any calculation, and/or any dependency, among examples of use.

The following aspects are illustrative only and may be combined with other aspects or teachings described herein, without limitation.

Aspect 1 is a method of wireless communication at a user equipment (UE), comprising: receiving a multicast channel scheduling information (MSI) medium access control-control element (MAC-CE) scheduling multiple multicast traffic channel (MTCH) transmissions in a multicast channel (MCH) scheduling period; and receiving one or more of the multiple MTCH transmissions based on scheduling information in the MSI MAC-CE and a scheduling delay between the MSI MAC-CE and a first MTCH transmission of the multiple MTCH transmissions that is based at least in part on a threshold time gap.

In aspect 2, the method of aspect 1 further includes that the threshold time gap includes a minimum time gap between the MSI MAC-CE and the first MTCH transmission scheduled by the MSI MAC-CE.

In aspect 3, the method of aspect 1 or aspect 2 further includes that the threshold time gap corresponds to a processing time threshold.

In aspect 4, the method of aspect 3 further includes that the processing time threshold has a defined value.

In aspect 5, the method of any of aspects 1-4 further includes that the multiple MTCH transmissions include at least one time-interleaved MTCH transmission.

In aspect 6, the method of any of aspects 1-5 further includes that the scheduling delay between the MSI MAC-CE and the first MTCH transmission scheduled by the MSI MAC-CE is further based on an amount of remaining MTCH transmission that was scheduled by a prior MSI MAC-CE.

In aspect 7, the method of any of aspects 1-6 further includes that the scheduling delay is based on one of: the threshold time gap, if the threshold time gap is larger than a time for the remaining MTCH transmission that was scheduled by the prior MSI MAC-CE, or the time for the remaining MTCH transmission that was scheduled by a prior MSI MAC-CE, if the threshold time gap is not larger than the time for the remaining MTCH transmission that was scheduled by the prior MSI MAC-CE.

In aspect 8, the method of any of aspects 1-7 further includes skipping buffering based on the scheduling delay between the MSI MAC-CE and the first MTCH transmission scheduled by the MSI MAC-CE.

Aspect 9 is an apparatus for wireless communication at a UE, comprising: at least one memory; and at least one processor coupled to the at least one memory and, based at least in part on information stored in the at least one memory, the at least one processor is configured to perform the method of any of aspects 1-8.

Aspect 10 is an apparatus for wireless communication at a UE, comprising: one or more memories and one or more processors coupled to the one or more memories, the wherein the one or more memories are configured to perform the method of any of aspects 1-8.

Aspect 11 is an apparatus for wireless communication at a UE, comprising: memory circuitry; and processor circuitry coupled to the memory circuitry, the processor circuitry is configured to perform the method of any of aspects 1-8.

Aspect 12 is an apparatus for wireless communication at a UE, comprising means for performing each step in the method of any of aspects 1-8.

Aspect 13 is the apparatus of any of aspects 9 to 12, further comprising a transceiver configured to receive or to transmit in association with the method of any of aspects 1-8.

Aspect 14 is a computer-readable medium storing computer executable code at a UE, the code when executed by at least one processor causes the at least one processor to perform the method of any of aspects 1-8.

Aspect 15 is a method of wireless communication at a network node, comprising: transmitting a multicast channel scheduling information (MSI) medium access control-control element (MAC-CE) scheduling multiple multicast traffic channel (MTCH) transmissions in a multicast channel (MCH) scheduling period; and transmitting the multiple MTCH transmissions based on scheduling information in the MSI MAC-CE and a scheduling delay between the MSI MAC-CE and a first MTCH transmission of the multiple MTCH transmissions that is based at least in part on a threshold time gap.

In aspect 16, the method of aspect 15 further includes that the threshold time gap includes a minimum time gap between the MSI MAC-CE and the first MTCH transmission scheduled by the MSI MAC-CE.

In aspect 17, the method of aspect 14 or aspect 15 further includes that the threshold time gap corresponds to a processing time threshold.

In aspect 18, the method of aspect 17 further includes that the processing time threshold has a defined value.

In aspect 19, the method of any of aspects 14 to 18 further includes that the multiple MTCH transmissions include at least one time-interleaved MTCH transmission.

In aspect 20, the method of any of aspects 14 to 19 further includes that the scheduling delay between the MSI MAC-CE and the first MTCH transmission scheduled by the MSI MAC-CE is further based on an amount of remaining MTCH transmission that was scheduled by a prior MSI MAC-CE.

In aspect 21, the method of any of aspects 14 to 20 further includes that the scheduling delay is based on one of: the threshold time gap if the threshold time gap is larger than a time for the remaining MTCH transmission that was scheduled by the prior MSI MAC-CE, or the time for the remaining MTCH transmission that was scheduled by a prior MSI MAC-CE if the threshold time gap is not larger than the time for the remaining MTCH transmission that was scheduled by the prior MSI MAC-CE.

Aspect 22 is an apparatus for wireless communication at a network node, comprising: at least one memory; and at least one processor coupled to the at least one memory and, based at least in part on information stored in the at least one memory, the at least one processor is configured to perform the method of any of aspects 15-21.

Aspect 23 is an apparatus for wireless communication at a network node, comprising: one or more memories and one or more processors coupled to the one or more memories, the wherein the one or more memories are configured to perform the method of any of aspects 15-21.

Aspect 24 is an apparatus for wireless communication at a network node, comprising: memory circuitry; and processor circuitry coupled to the memory circuitry, the processor circuitry is configured to perform the method of any of aspects 15-21.

Aspect 25 is an apparatus for wireless communication at a network node, comprising means for performing each step in the method of any of aspects 15-21.

Aspect 26 is the apparatus of any of aspects 22 to 25, further comprising a transceiver configured to receive or to transmit in association with the method of any of aspects 15-21.

Aspect 27 is a computer-readable medium storing computer executable code at a network node, the code when executed by at least one processor causes the at least one processor to perform the method of any of aspects 15-21.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
receive a multicast channel scheduling information (MSI) medium access control-control element (MAC-CE) scheduling multiple multicast traffic channel (MTCH) transmissions in a multicast channel (MCH) scheduling period; and
receive one or more of the multiple MTCH transmissions based on scheduling information in the MSI MAC-CE and a scheduling delay between the MSI MAC-CE and a first MTCH transmission of the multiple MTCH transmissions that is based at least in part on a threshold time gap.

2. The apparatus of claim 1, wherein the threshold time gap includes a minimum time gap between the MSI MAC-CE and the first MTCH transmission scheduled by the MSI MAC-CE.

3. The apparatus of claim 2, wherein the threshold time gap corresponds to a processing time threshold.

4. The apparatus of claim 3, wherein the processing time threshold has a defined value.

5. The apparatus of claim 1, wherein the multiple MTCH transmissions include at least one time-interleaved MTCH transmission.

6. The apparatus of claim 1, wherein the scheduling delay between the MSI MAC-CE and the first MTCH transmission scheduled by the MSI MAC-CE is further based on an amount of remaining MTCH transmission that was scheduled by a prior MSI MAC-CE.

7. The apparatus of claim 6, further comprising a transceiver coupled to the at least one processor, wherein the scheduling delay is based on one of:
the threshold time gap, if the threshold time gap is larger than a time for the remaining MTCH transmission that was scheduled by the prior MSI MAC-CE, or
the time for the remaining MTCH transmission that was scheduled by the prior MSI MAC-CE, if the threshold time gap is not larger than the time for the remaining MTCH transmission that was scheduled by the prior MSI MAC-CE.

8. The apparatus of claim 1, wherein the at least one processor is further configured to:
skip buffering based on the scheduling delay between the MSI MAC-CE and the first MTCH transmission scheduled by the MSI MAC-CE.

9. The apparatus of claim 1, further comprising:
at least one transceiver coupled to the at least one processor, wherein the at least one processor is configured to receive the MSI MAC-CE and the one or more of the multiple MTCH transmissions via the at least one transceiver.

10. An apparatus for wireless communication at a network node, comprising:
at least one memory; and
at least one processor coupled to the at least one memory and, based at least in part on information stored in the at least one memory, the at least one processor is configured to:
transmit a multicast channel scheduling information (MSI) medium access control-control element (MAC-CE) scheduling multiple multicast traffic channel (MTCH) transmissions in a multicast channel (MCH) scheduling period; and
transmit the multiple MTCH transmissions based on scheduling information in the MSI MAC-CE and a scheduling delay between the MSI MAC-CE and a first MTCH transmission of the multiple MTCH transmissions that is based at least in part on a threshold time gap.

11. The apparatus of claim 10, wherein the threshold time gap includes a minimum time gap between the MSI MAC-CE and the first MTCH transmission scheduled by the MSI MAC-CE.

12. The apparatus of claim 11, wherein the threshold time gap corresponds to a processing time threshold.

13. The apparatus of claim 12, wherein the processing time threshold has a defined value.

14. The apparatus of claim 10, wherein the multiple MTCH transmissions include at least one time-interleaved MTCH transmission.

15. The apparatus of claim 10, wherein the scheduling delay between the MSI MAC-CE and the first MTCH transmission scheduled by the MSI MAC-CE is further based on an amount of remaining MTCH transmission that was scheduled by a prior MSI MAC-CE.

16. The apparatus of claim 15, wherein the scheduling delay is based on one of:
the threshold time gap if the threshold time gap is larger than a time for the remaining MTCH transmission that was scheduled by the prior MSI MAC-CE, or
the time for the remaining MTCH transmission that was scheduled by the prior MSI MAC-CE if the threshold time gap is not larger than the time for the remaining MTCH transmission that was scheduled by the prior MSI MAC-CE.

17. A method of wireless communication at a user equipment (UE), comprising:
receiving a multicast channel scheduling information (MSI) medium access control-control element (MAC-CE) scheduling multiple multicast traffic channel (MTCH) transmissions in a multicast channel (MCH) scheduling period; and
receiving one or more of the multiple MTCH transmissions based on scheduling information in the MSI MAC-CE and a scheduling delay between the MSI MAC-CE and a first MTCH transmission of the multiple MTCH transmissions that is based at least in part on a threshold time gap.

18. The method of claim 17, wherein the multiple MTCH transmissions include at least one time-interleaved MTCH transmission.

19. The method of claim 17, wherein the threshold time gap corresponds to a processing time threshold, and the scheduling delay is based on one of:
the threshold time gap, if the threshold time gap is larger than a time for a remaining MTCH transmission that was scheduled by a prior MSI MAC-CE, or
the time for the remaining MTCH transmission that was scheduled by the prior MSI MAC-CE, if the threshold time gap is not larger than the time for the remaining MTCH transmission that was scheduled by the prior MSI MAC-CE.

20. The method of claim 17, further comprising:
skipping buffering based on the scheduling delay between the MSI MAC-CE and the first MTCH transmission scheduled by the MSI MAC-CE.
